(19) United States
(12) Patent Application Publication
(10) Pub. No.: US 2023/0330828 A1
(43) Pub. Date: Oct. 19, 2023

(54) IMPACT DRIVER WITH RETRACTABLE BIT-HOLDER

(71) Applicant: Hermann Frühm, Pitt Meadows (CA)

(72) Inventor: Hermann Frühm, Pitt Meadows (CA)

(21) Appl. No.: 18/035,419

(22) PCT Filed: Dec. 8, 2021
(86) PCT No.: PCT/CA2021/051762

§ 371 Date: May 4, 2023

Related U.S. Application Data
(60) Provisional application No. 63/125,113, filed on Dec. 14, 2020.

(51) Int. Cl. B25F 5/02; B25D 11/00

(52) U.S. Cl. CPC B25F 5/029; B25D 11/00

(57) ABSTRACT

A retractable bit holder for a bit-using power tool provides storage for bits within the power tool. The bit holder has a tube that slides along a cylindrical member of the casing of the power tool between open and closed positions. A bit-mounting member extends radially outwardly from the tube and has a plurality of clip members projecting from it, the clip members being configured for removably holding bits. The bit-mounting member has a first portion arranged for holding bits at a greater distance from the tube than a second portion of the bit-mounting member, thereby providing storage of bits having a range of diameters. The bit holder is sized to provide a recess between the bit-mounting member and an internal wall within the casing of the power tool. The bit holder may optionally be contained in a bit cartridge that is detachable from the power tool.

### FIELD OF THE INVENTION

The invention pertains to power tools that use bits, such as impact drivers and power drills, and that have retractable bit holders to store the bits within the casing of the power tool or in a detachable cartridge.

### BACKGROUND OF THE INVENTION

Power tools having integral bit storage compartments are known in the industry. They enable the user to have the bits readily available for use without requiring a separate bit storage case.

WO 00/09295 to Fruhm, published Feb. 24, 2000, discloses a power drill with an integral, retractable bit holder, in which the bits are held by clips in an array about the circumference of a cylindrical member within the casing of the power drill. The device is useful for holding bits of the same diameter. However, modern bit-using power tools such as impact drivers operate with bits having a range of diameters, such as hex bits, socket adaptors, screwdriver bits, nut drivers, nut setters and pilot drills. Some of these bits have diameters that are much larger than others. Such bits cannot be held by known integral bit holders. There is a need in the power tool industry for a device which can provide integral storage within the power tool of bits having a range of diameters.

### SUMMARY OF THE INVENTION

The invention provides a bit holder, and a power tool with an integral bit holder, which enables convenient storage within the casing of the power tool of bits having different diameters.

One aspect of the invention provides a retractable bit holder for a bit-using power tool, comprising: a tube configured for longitudinal slidable movement along a cylindrical member of a casing of the power tool between open and closed positions; a bit-mounting member extending radially outwardly from the tube and having a plurality of clip members projecting from and circumferentially spaced around the bit-mounting member, each of the clip members being configured for removably retaining a bit; the bit-mounting member having a first portion with an outer surface at a first radial distance from the tube and a second portion with an outer surface at a second radial distance from the tube, the first radial distance being greater than the second radial distance; the bit holder being sized to provide a recess between the bit-mounting member and an internal wall within the casing of the power tool in the closed position. In other embodiments of the bit holder, the bit-mounting member has more than two portions thereof with an outer surface at different radial distances from the tube, for example, three, four, five or more such portions.

Another aspect of the invention provides a bit-using power tool, such as an impact driver, having a casing with an internal cylindrical member, an internal wall spaced from the cylindrical member, and a retractable bit holder, the bit holder comprising: a tube configured for longitudinal slidable movement along the cylindrical member of the casing between open and closed positions; a bit-mounting member extending radially outwardly from the tube and having a plurality of clip members projecting from and circumferentially spaced around the bit-mounting member, each of the clip members being configured for removably retaining a bit; the bit-mounting member having a first portion with an outer surface at a first radial distance from the tube and a second portion with an outer surface at a second radial distance from the tube, the first radial distance being greater than the second radial distance; the bit holder being sized to provide a recess between the bit-mounting member and the internal wall of the casing in the closed position.

According to another aspect of the invention, the bit-holder is within a cartridge that is detachably connected to the power tool.

Further aspects of the invention and features of specific embodiments are described below.

### BRIEF DESCRIPTION OF THE DRAWINGS

FIG. 1 is a schematic, partly cutaway, side elevation view of an impact driver with a bit holder mounted in the casing of the impact driver, in the open position.

FIG. 2 is a view similar to FIG. 1, with the bit holder in the closed position within the casing.

FIG. 3 is a longitudinal cross-sectional view of the bit holder-receiving portion of the casing and the bit holder in the open position.

FIG. 4 is a view similar to FIG. 3, with the bit holder in the closed position.

FIG. 5 is a perspective view of the bit holder-receiving portion of the casing and the bit holder in the open position.

FIG. 6 is a cross-sectional view on the line 6-6 of FIG. 4.

FIG. 7 is an end view of the bit holder from its outer end, without the end cap and outer end collar.

FIG. 8 is a perspective view of the bit holder loaded with bits.

FIG. 9 is a perspective view similar to FIG. 8, without the outer end collar.

FIG. 10 is an elevational view of the bit holder loaded with bits.

FIG. 11 is an end view of the bit holder from its outer end, without the end cap and outer end collar, loaded with bits.

FIG. 12, is a schematic side elevation view of an embodiment of the impact driver with a detachable bit cartridge, with the bit holder in the open position in the bit cartridge.

FIG. 13, is a view similar to FIG. 12, with the bit cartridge detached from the impact driver, the bit holder being in the closed position.

FIG. 14 is a longitudinal cross-sectional view of the detachable bit cartridge, with the bit holder in the closed position.

FIG. 15 is a perspective view of the end cap of the first section of the casing of the embodiment of FIGS. 12-14.

### DETAILED DESCRIPTION

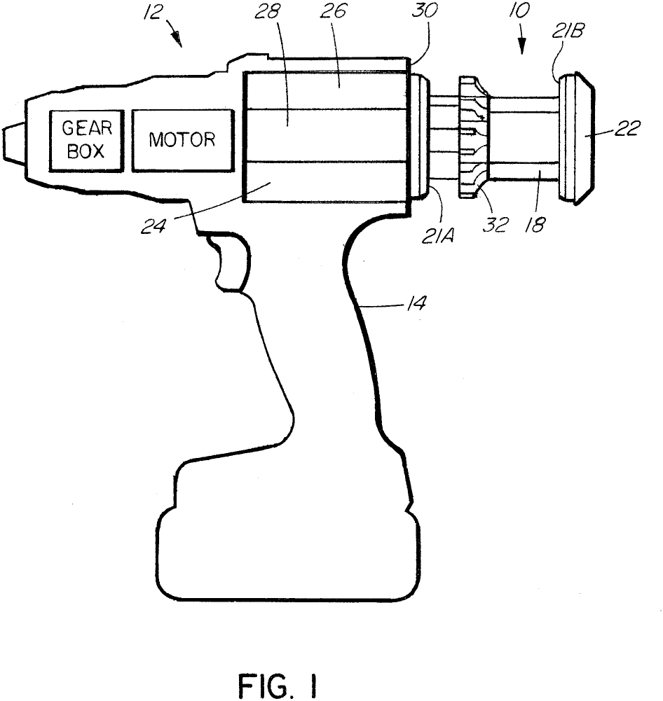

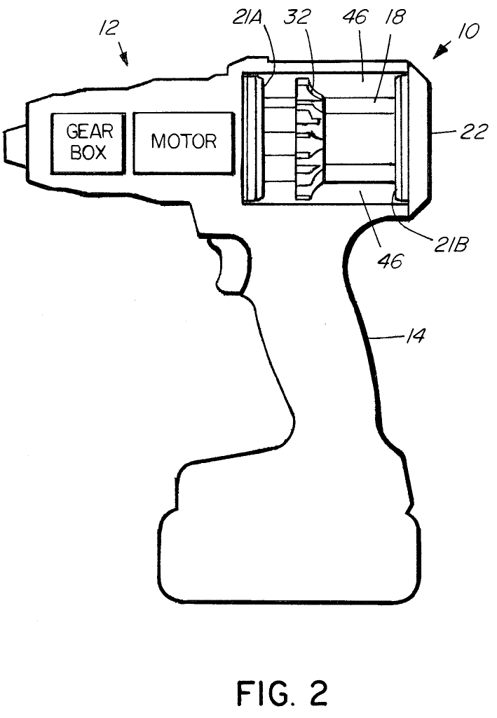

The bit holder 10 is for use in combination with an impact driver 12 or other bit-using power tool, such as a power drill or screwdriver. As seen in FIGS. 1 and 2, it is configured to be held within and be retractable from the casing 14 of the impact driver and to hold bits 16 having various diameters, including hex bits, socket adaptors, screwdriver bits, nut drivers and pilot drills. The bit holder 10 comprises a tube 18, a bit-mounting member 20, two collars 21A, 21B and an end cap 22. The tube and the bit-mounting members may be integrally formed of molded plastic.

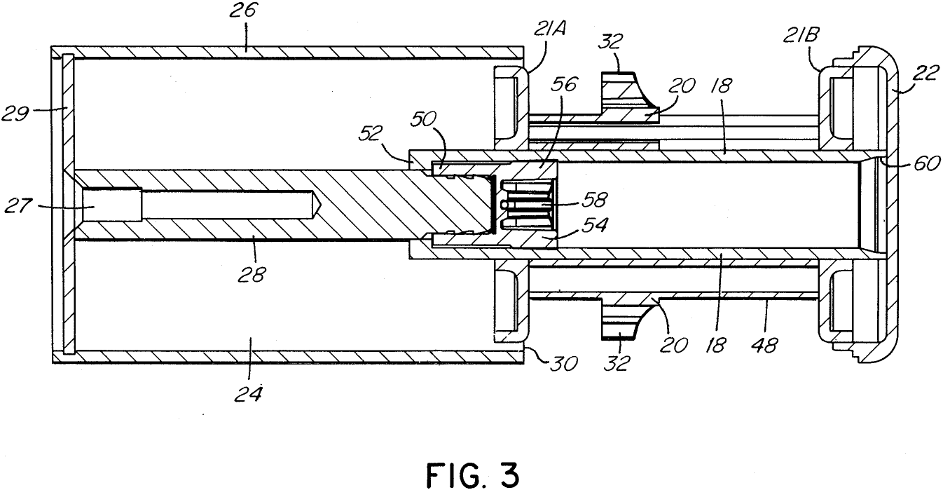

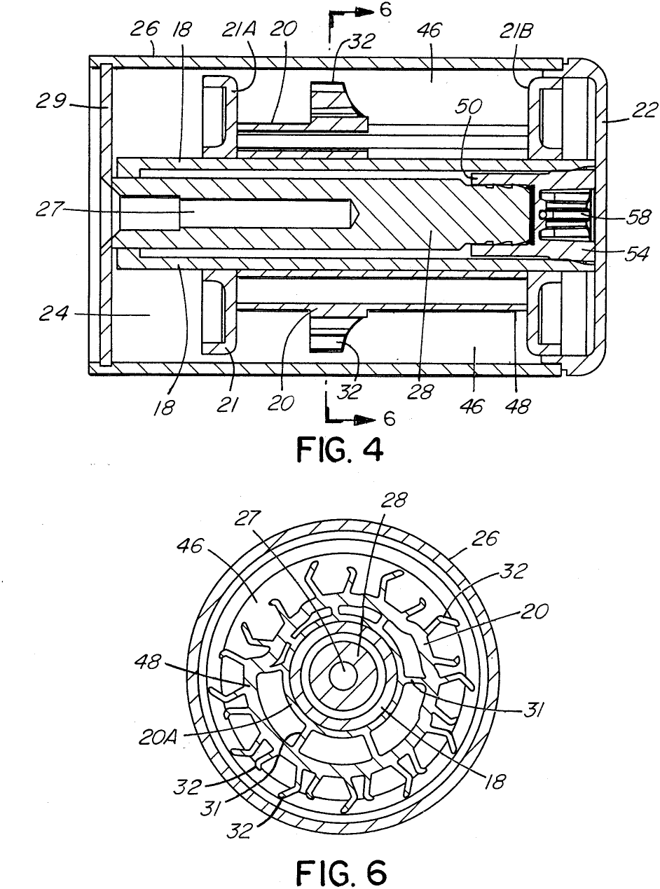

Referring to FIGS. 3 and 4, the casing 14 of the impact driver has an interior cylindrical cavity 24 defined by a circumferential wall 26. Within this cavity a cylindrical member 28 is affixed to the casing concentrically with the wall 26 by a mounting screw 27 and support plate 29 and extends rearwardly towards the open back end 30 of the casing. (In this disclosure, references to “forward” and “rearward” are relative to the power tool, i.e., “rearward” is to the right in the view of FIG. 1.)

The cylindrical member 28 fits within the tube 18 of the bit holder, the tube being configured for longitudinal sliding movement on the cylindrical member between an open position, in which the bit holder extends from the casing 14, and a closed position, in which the bit holder is positioned within the casing, with only the end cap 22 being outside it. The tube 18 is also rotatable on the cylindrical member 28 so that a user can rotate the bit holder to select a specific bit.

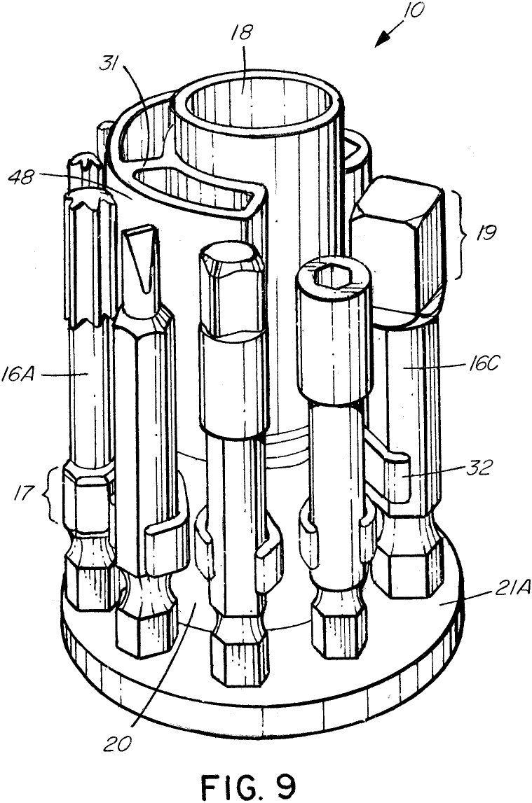

The bit-mounting member 20 extends radially outwardly from the tube 18. It has a portion 20A directly at the outer surface of the tube 18 and a portion 20B that is spaced radially outwardly from the tube 18 and the portion 20A by radially-extending stand-offs 31, as seen in FIGS. 6, 7 and 9. Clip members 32 are arranged around the circumference of the bit-mounting member, at its radially-outward surface, spaced apart from each other and configured for removably retaining the bits 16.

Each bit has a portion 17 of its length with a common diameter, and the clip members are uniform in size and hold the bits by this common diameter portion. For example, the common diameter portion 17 of the bits may have a diameter of about 0.248 to 0.250 inches measured across the flat portions of a hexagonal shank, or about 0.280 to 0.282 inches measured across the corners of the hexagonal shank. Some of the bits have a portion 19 of their length with a larger diameter than that of the common diameter portion 17. For example, while conventional hex bits 16A are substantially uniform in diameter throughout their length, a nut driver 16B may have a portion 19 with a larger maximum diameter, e.g., 0.560 to 0.565 inches, and a socket adaptor 16C may have a portion 19 with a maximum diameter of 0.303 to 0.308 inches.

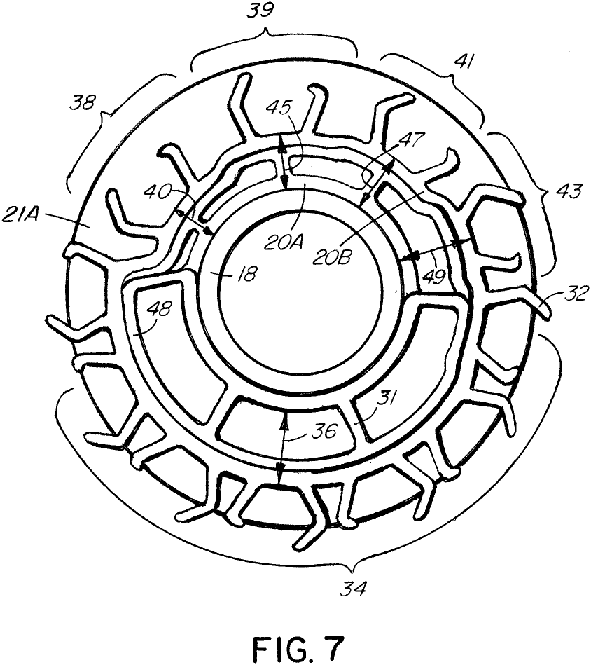

The bit-mounting member 20 is configured to hold bits 16 having different maximum diameters. To accommodate such bits, the bit-mounting member 20 has portions thereof with an outer surface at different radial distances from the tube 18, as shown in FIG. 7. There are at least two such portions having an outer surface with different radial distances, to accommodate bits having at least two different maximum diameters. In the illustrated embodiments of the bit holder 10, the bit-mounting member 20 has five such portions, namely, a first portion 34 with an outer surface at a first radial distance 36 from the tube 18, a second portion 38 with an outer surface at a second radial distance 40 from the tube, a third portion 39 with an outer surface at a third radial distance 45 from the tube, a fourth portion 41 with an outer surface at a fourth radial distance 47 from the tube, and a fifth portion 43 with an outer surface at a fifth radial distance 49 from the tube.

The first radial distance 36 is greater than the second radial distance 40, such that bits held by clip members 32 on the second portion 38 of the bit-mounting member are positioned closer to the tube 18 than bits held by clip members on the first portion 34 of the bit-mounting member. Similarly, the third radial distance 45, the fourth radial distance 47 and the fifth radial distance 49 are less than the first radial distance 36 and are different from the second radial distance 40 and from each other, being intermediate to radial distances 36 and 40, to accommodate bits of various different maximum diameters.

In other embodiments of the bit holder, the bit-mounting member 20 has fewer or more portions thereof with an outer surface at different radial distances from the tube 18, for example, two, three, four, or more than five such portions.

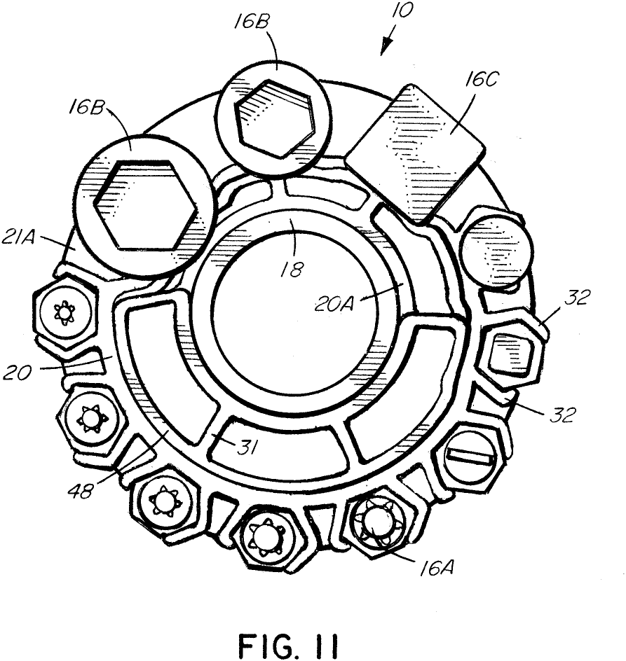

As seen in FIGS. 7, 9 and 11, the first portion 34 of the bit-mounting member 20 has a part 48 that extends longitudinally along one circumferential portion of the tube 18 (this is approximately half of the circumference in the illustrated embodiment). The remaining circumferential portion of the tube is not covered by the longitudinal extension 48 of the bit-mounting member 20. When the bit holder 10 is in the closed position within the casing 14, there is an annular recess 46 between the bit-mounting member (and the bits held by it) and the internal circumferential wall 26 of the casing. The radial distance within the annular recess 46 between the circumferential wall 26 and the uncovered portion of the tube 18 is greater than the radial distance between the circumferential wall 26 and the longitudinally-extending part 48 of the bit-mounting member. This results in a radially larger space within the annular recess 46 for the storage of bits 16 having relatively larger maximum diameters, such as nut drivers 16B and socket adaptors 16C, held by the clip members 32 on the second portion 38, the third portion 39, the fourth portion 41 and the fifth portion 43 of the bit-mounting member.

The bits 16 held by clip members 32 on the first portion 34 of the bit-mounting member 20 are adjacent to the longitudinally-extending part 48 of the first portion 34. Since these bits, such as hex bits 16A, have a relatively smaller maximum diameter, they fit snugly into this relatively smaller space between the bit-mounting member 20 and the circumferential wall 26 of the casing.

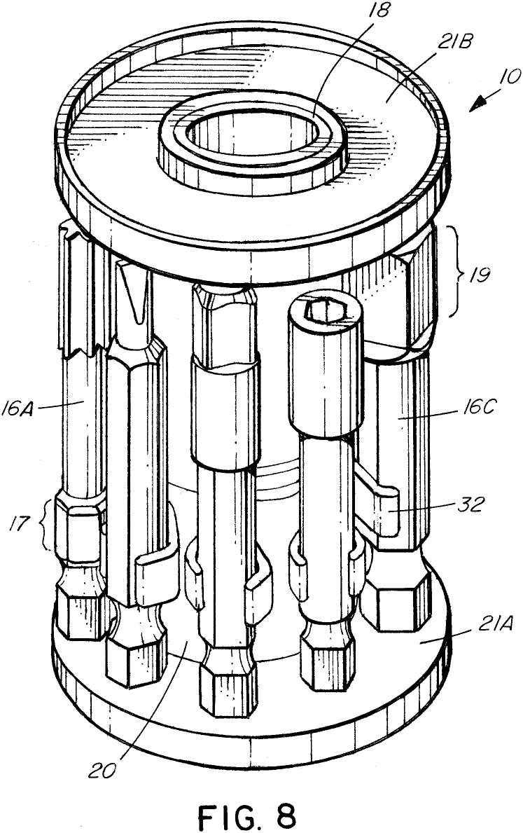

As seen in FIG. 8, the bit holder 10 includes two collars 21A, 21B fitted snugly around the opposed inner and outer ends respectively of the tube 18 to prevent the bits 16 from escaping longitudinally from the bit holder, should they not be firmly seated in the clip members. The bit holder also includes a cap 22 affixed on its outward end. This cap covers the open back end 30 of the casing and provides a grip for a user to retract the bit holder 10 from the casing 14.

In some embodiments, means are provided to prevent complete separation of the bit holder from the casing when the bit holder is slidably moved from the closed position to the open position. For example, as shown in FIGS. 3 and 4, this may take the form of an outwardly-protruding ring 50 around the outward end of the cylindrical member 28 and an inwardly protruding ring or shoulder 52 around the inward end of the tube 10. When the bit holder is moved into the open position, the opposing faces of the rings 50, 52 are brought into abutment against one another, preventing separation of the bit holder from the casing.

In other embodiments, this separation-prevention means 50, 52 is not provided, in order to permit the removal of the bit holder 10 from the casing 14 and the interchange of separate bit holders pre-loaded with different bits. A bit holder 10 removed from the casing may be kept in a separate retrieval canister for convenient access and use.

Retaining means are provided to retain the bit holder 10 in place within the cavity 24 when it is in the closed position. Suitable retaining means for this purpose are known in the art, as disclosed for example in WO 00/09295 and US 7,258,046 to Fruhm. As seen in FIGS. 3 and 4, the retaining means comprises a retaining pin 54 affixed to the outward end of the cylindrical member 28. The retaining pin has radially outwardly-protruding flexible finger-like members 56, separated by slit apertures, and holds a spring 58 arranged to bias the finger-like members 56 outwardly. The retaining means includes a bevelled rim 60 of the tube 18 at the inward face of the end cap 22. As the bit holder 10 is slid into the closed position, the finger-like members 56 are compressed radially inwardly, and when they encounter the bevelled rim 60 they snap radially outwardly to seat themselves within the bevelled rim. This releasably retains the bit holder 10 in the closed position.

The retaining pin 54 also creates the sliding frictional fit of the bit holder along the cylindrical member 28 of the casing, by virtue of the finger-like members 56 pressing on the inner surface of the tube 18 as the bit holder 10 is moved between the open and closed positions.

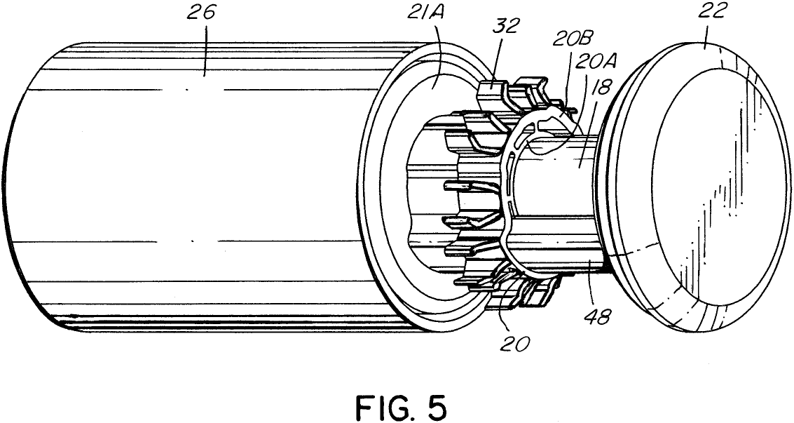

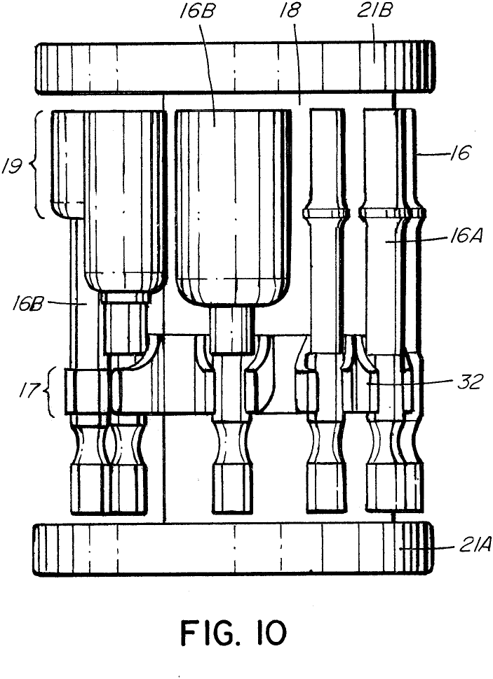

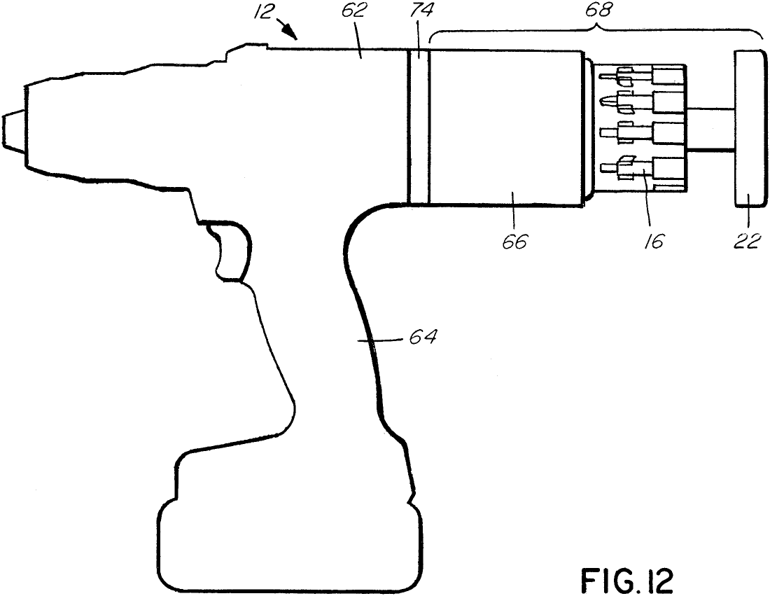

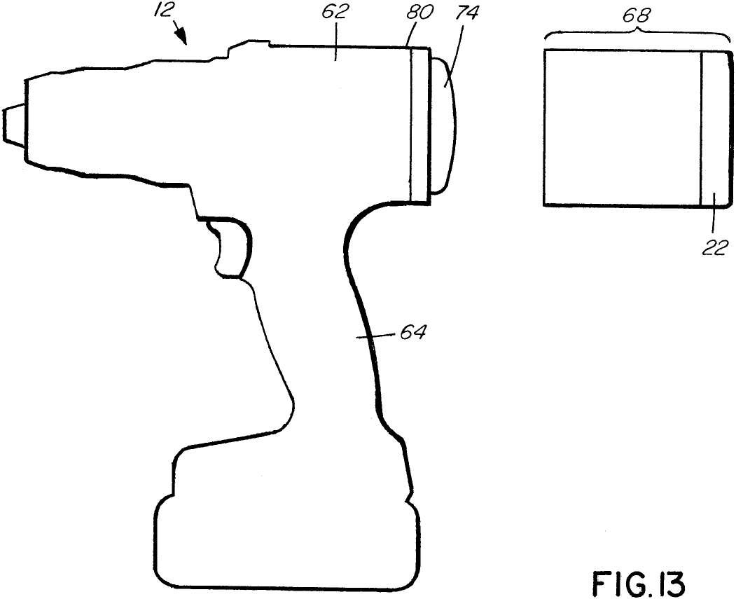

FIGS. 12-15 illustrate an embodiment of the invention in which the bit holder 10 is in a bit cartridge 68 that is detachable from the power tool 12. The structure and operation of the bit holder 10 in this embodiment is essentially the same as in the embodiment of FIGS. 1-11. This detachable cartridge embodiment facilitates the interchange of bit cartridges that are pre-loaded with different bits. It is distinct from the embodiments referred to above in which the bit holder 10 is removable from the casing 14 of the power tool.

In the embodiment pf FIGS. 12-15, the power tool 12 has a casing 14 which comprises two parts, namely a casing first part 62 and a casing second part 66. The casing first part has the power tool handle 64 and contains the motor and all parts of the power tool apart from the detachable bit cartridge.

The casing second part 66 comprises the casing wall 26 (corresponding to the wall 26 of the embodiment of FIGS. 1-11) and contains the cylindrical member 28. The casing second part 66 holds the bit-holder 10. These parts together comprise the bit cartridge 68.

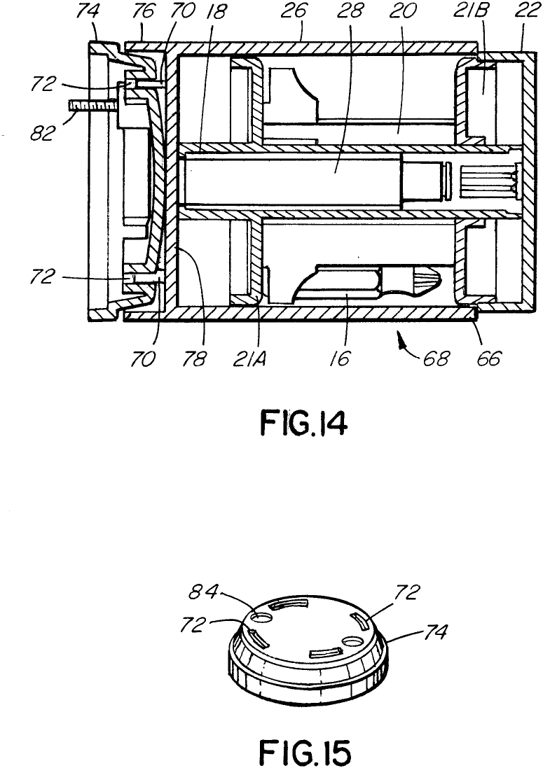

Referring to FIGS. 14 and 15, the wall 26 of the bit cartridge 68 extends forwardly of an end wall 78 of the casing second part 66, forming a short cylindrical extension 76. Four bayonet members 70 extend into this extending section 76 from the end wall 78. The bayonet members have a straight part and an angled part.

An end cap 74 is attached to the rearward end 80 of the casing first part 62 by means of screws 82 that extend through holes 84 in the end cap and into the body of the casing first part. The end cap 74 is configured to fit partly within the extending section 76 of the bit cartridge. The end cap has four slots 72 configured to receive the bayonet members 70. The slots 72 and bayonet members 70 are configured such that when the bayonet members 70 are inserted into the slots 72 and the bit cartridge 68 is rotated, angled end portions of the bayonet members engage the end cap 74 and releasably lock the bit cartridge 68 to the casing first part 62. Rotation of the bit cartridge in the opposite direction disengages the bayonet members from the end cap to release the bit cartridge. The user can then replace the bit cartridge by another bit cartridge holding different bits.

Throughout the foregoing description and the drawings, in which corresponding and like parts are identified by the same reference characters, specific details have been set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As will be apparent to those skilled in the art in the light of the foregoing disclosure, many alterations and modifications are possible in the practice of this invention without departing from the scope thereof. Accordingly, the scope of the invention is to be construed in accordance with the following claims.

1. A retractable bit holder for a bit-using power tool, comprising:
a tube configured for longitudinal slidable movement along a cylindrical member of a casing of the power tool between open and closed positions;
a bit-mounting member extending radially outwardly from the tube and having a plurality of clip members projecting from and circumferentially spaced around the bit-mounting member, each of the clip members being configured for removably retaining a bit;
the bit-mounting member having a first portion with an outer surface at a first radial distance from the tube and a second portion with an outer surface at a second radial distance from the tube, the first radial distance being greater than the second radial distance;
the bit holder being sized to provide a recess between the bit-mounting member and an internal wall within the casing of the power tool in the closed position.

2. A bit holder according to claim 1, wherein the bit-mounting member further comprises a third portion with an outer surface at a third radial distance from the tube, the third radial distance being less than the first radial distance and different than the second radial distance.

3. A bit holder according to claim 2, wherein the bit-mounting member further comprises a fourth portion with an outer surface at a fourth radial distance from the tube, the fourth radial distance being less than the first radial distance and different than the second and third radial distances.

4. A bit holder according to claim 3, wherein the bit-mounting member further comprises a fifth portion with an outer surface at a fifth radial distance from the tube, the fifth radial distance being less than the first radial distance and different than the second, third and fourth radial distances.

5-6. (canceled)

7. A bit holder according to claim 1, wherein the first portion of the bit-mounting member has a part that extends longitudinally along one circumferential portion of the tube, such that a radial distance in the recess between the internal wall of the casing and the outer surface of the remaining portion of the tube is greater than a radial distance in the recess between the internal wall of the casing and the longitudinally-extending part of the first portion of the bit-mounting member.

8. A bit holder according to claim 1, further comprising a plurality of radially-extending stand-off members between the tube and the bit-mounting member.

9. A bit holder according to claim 8, wherein the radially-extending stand-off members adjacent to the first portion of the bit-mounting member are longer in radial extension than the longitudinally-extending radial members adjacent to the second portion of the bit-mounting member.

10. (canceled)

11. A bit holder according to claim 1, further comprising a plurality of the bits, some of said bits having a first maximum diameter and others of said bits having a second maximum diameter, the first maximum diameter being smaller than the second maximum diameter, the bits having the first maximum diameter being retained by the clip members projecting from the first portion of the bit-mounting member and the bits having the second maximum diameter being retained by the clip members projecting from the second portion of the bit-mounting member.

12. A bit-using power tool having a casing with an internal cylindrical member, an internal wall spaced from the cylindrical member, and a retractable bit holder, the bit holder comprising:
a tube configured for longitudinal slidable movement along the cylindrical member of the casing between open and closed positions;
a bit-mounting member extending radially outwardly from the tube and having a plurality of clip members projecting from and circumferentially spaced around the bit-mounting member, each of the clip members being configured for removably retaining a bit;
the bit-mounting member having a first portion with an outer surface at a first radial distance from the tube and a second portion with an outer surface at a second radial distance from the tube, the first radial distance being greater than the second radial distance;
the bit holder being sized to provide a recess between the bit-mounting member and the internal wall of the casing in the closed position.

13. A power tool according to claim 12, wherein the power tool is an impact driver.

14. (canceled)

15. A power tool according to claim 12, wherein the first portion of the bit-mounting member has a part that extends longitudinally along one circumferential portion of the tube, such that a radial distance in the recess between the internal wall of the casing and the outer surface of the remaining circumferential portion is greater than a radial distance in the recess between the internal wall of the casing and the longitudinally-extending part of the first portion of the bit-mounting member.

16-19. (canceled)

20. A power tool according to claim 12, wherein the bit holder is detachable from the casing.

21. A power tool according to claim 12, further comprising retaining means to releasably retain the bit holder in the closed position.

22. A retractable bit holder according to claim 1, wherein the casing of the power tool comprises:
(i) a casing first part having a power tool handle;
(ii) a casing second part detachably connected to the casing first part, the casing second part comprising the cylindrical member and the wall of the casing;
the casing second part and the bit-holder comprising a bit cartridge that is detachable from the casing first part; and
(iii) attachment means for detachably connecting the bit cartridge to the casing first part.

23. A retractable bit holder according to claim 22, wherein the attachment means comprises bayonet members on the casing second part and bayonet-receiving openings on the casing first part.

24. A retractable bit holder according to claim 23, wherein the wall of the casing second part has an extending section that extends forwardly of an end wall of the casing second part, and the bayonet members are positioned within the extending section.

25-26. (canceled)

27. A bit cartridge for a bit-using power tool, comprising:
(a) a casing;
(b) a retractable bit holder comprising:
(i) a tube configured for longitudinal slidable movement along a cylindrical member of the casing between open and closed positions;
(ii) a bit-mounting member extending radially outwardly from the tube and having a plurality of clip members projecting from and circumferentially spaced around the bit-mounting member, each of the clip members being configured for removably retaining a bit;
(iii) the bit-mounting member having a first portion with an outer surface at a first radial distance from the tube and a second portion with an outer surface at a second radial distance from the tube, the first radial distance being greater than the second radial distance;
(iv) the bit holder being sized to provide a recess between the bit-mounting member and a wall of the casing in the closed position; and
(c) attachment means for detachably connecting the bit cartridge to a casing of the power tool.

28-36. (canceled)

37. A bit cartridge according to claim 27, further comprising a plurality of the bits, some of said bits having a first maximum diameter and others of said bits having a second maximum diameter, the first maximum diameter being smaller than the second maximum diameter, the bits having the first maximum diameter being retained by the clip members projecting from the first portion of the bit-mounting member and the bits having the second maximum diameter being retained by the clip members projecting from the second portion of the bit-mounting member.

38-44. (canceled)

45. A bit holder according to claim 1, wherein each said bit has a portion along its length with a common diameter, and the clip members are configured to hold the bits by said common diameter portion, the common diameter portion of each said bit held on the first portion of the bit-mounting member being at a greater radial distance from the tube than each said bit held on the second portion .

46. A power tool according to claim 12, wherein each said bit has a portion along its length with a common diameter, and the clip members are configured to hold the bits by said common diameter portion, the common diameter portion of each said bit held on the first portion of the bit-mounting member being at a greater radial distance from the tube than each said bit held on the second portion.

47. (canceled)
